(19) United States
(12) Patent Application Publication
(10) Pub. No.: US 2021/0114611 A1
(43) Pub. Date: Apr. 22, 2021

(54) SYSTEM FOR PERFORMING EFFECTIVE IDENTIFICATION OF VEHICLE LINE PRESSING AND GIVING EARLY PROMPT

(71) Applicant: FU ZHOU UNIVERSITY, Fuzhou, Fujian (CN)

(72) Inventors: Zhifeng CHEN, Fuzhou, Fujian (CN); Ente GUO, Fuzhou, Fujian (CN); Zhenjia FAN, Fuzhou, Fujian (CN); Chenhao PEI, Fuzhou, Fujian (CN); Yanan CHEN, Fuzhou, Fujian (CN); Liqin HUANG, Fuzhou, Fujian (CN); Lin PAN, Fuzhou, Fujian (CN)

(73) Assignee: FU ZHOU UNIVERSITY, Fuzhou, Fujian (CN)

(21) Appl. No.: 17/047,743

(22) PCT Filed: Jan. 17, 2019
(86) PCT No.: PCT/CN2018/119028

§ 371 Date: Oct. 15, 2020

(30) Foreign Application Priority Data
Jan. 17, 2019 (CN) 201810345892.7

(51) Int. Cl. B60W 50/14; B60W 30/08; G06K 9/00

(52) U.S. Cl. CPC B60W 50/14; B60W 2420/403; G06K 9/00798; B60W 30/08

(57) ABSTRACT

The present invention relates to a system for effectively identifying pressing line of vehicle and giving an early prompt, comprising an image acquisition module, a lane line extraction module, a distance calculation module and an early-warning judgment module. The image acquisition module acquires front images through an optical camera. The lane line extraction module processes the front images to extract lane lines in each of the images. The distance calculation module calculates a distance between the optical camera and each of left and right lane lines, and calculates the distance between the vehicle and each of the left and right lane lines through the position of the camera in the vehicle and vehicle dimensions. Then, the early-warning judgment module judges whether or not to give a driver an early-warning prompt. The present invention has the beneficial effects of acquisition of images with a single-lens camera, real-time calculation of the distance between the vehicle and each of the left and right lane lines and supply of an early warning to the driver. The present invention has the advantages of simple design, easy development, high reliability, no need of vehicle refitting and independence from the outside.

### BACKGROUND OF THE INVENTION

### 1. Technical Field

The present invention relates to a system for effectively identifying PRESSING LINE OF VEHICLE and giving an early-warning prompt.

### 2. Description of Related Art

Vehicles become popular for household use along with the development of scientific technologies. As automobiles bring convenience in traffic, increasing traffic accidents cause a threat to the safety of people and result in financial losses. People usually unconsciously ride lines when driving the vehicle. The vehicle riding on the line during driving occupies another lane, such that another vehicle behind towards the same direction cannot overtake or another vehicle towards the opposite direction cannot keep an effective distance, thereby resulting in occurrence of traffic accidents. Or, when the vehicle is captured by a traffic violation monitoring system when riding a line, the driver will be punished by the traffic control department due to a violation, thereby causing economic losses and deduction of driver's license points to the driver. For existing methods which giving an early warning for pressing line of vehicle by means of machine vision, a camera is usually pre-installed and the safety distance between the camera and a lane line is fixed.

### BRIEF SUMMARY OF THE INVENTION

For this reason, the objective of the present invention is to provide a system for effectively identifying pressing line of vehicle and giving an early-warning prompt.

To achieve the foregoing objective, the present invention adopts the following solution: A system for effectively identifying pressing line of vehicle and giving an early-warning prompt includes an image acquisition module, a lane line extraction module, a distance calculation module and an early-warning judgment module, characterized in that the image acquisition module acquires image information through an optical camera and inputs the image information into the lane line extraction module;

the lane line extraction module further includes an image pre-processing module and a straight line extraction module;

the image pre-processing module Graying the image, then smoothens the image by mean filtering, extracts margins in the image with a Canny operator, and removes small margins by opening operation to obtain pre-processed image information;

the straight line extraction module extracts a straight line within a limited angle by Hough conversion according to the pre-processed information judges whether a lane line is a yellow solid line using the original image color characteristics, judges a dotted line and a solid line through periodic gray conversion of the lane line to obtain lane line information, and inputs the lane line information into the distance calculation module;

the distance calculation module processes the lane line information, calculates a transverse distance between the vehicle and each of left and right lane lines, and inputs the calculation result into the pre-warning judgment module;

the pre-warning judgment module judges whether the transverse distance between the vehicle and each of left and right lane lines obtained by the distance calculation module through processing and calculation exceeds a pre-defined distance value for early warning, and if so, gives a driver an early-warning signal.

Further, the distance calculation module processes the lane line information, calculates a transverse distance between the vehicle and each of left and right lane lines by a method including the following steps:

S1: installing the optical camera at a windscreen of the vehicle, where the optical axis is parallel to the ground, the horizontal height is h, the distance to the head of the vehicle is a, the distance to the left side of the vehicle is b, and the focal length is f;

S2: processing, by the lane line extraction module, the image information acquired by the optical camera to obtain the left and right lane lines in the image that are plane projection of left and right lane lines on a pavement, where in an image coordinates system, the left and right lane lines are crossed at B(m₃,m₂) on a hidden line, the central line of the image and the hidden line are crossed at point A(m₁,m₂), and the angle between each of the left and right lane lines and the axis x of the image coordinates system is θ₁,θ₂;

S3: calculating the distance between the optical camera and each of the left and right lane lines;

where the distance between the optical camera and the left lane line is

$$d c l = \vert \frac{h f}{tan {θ}_{2} \sqrt{{f}^{2} + {( {m}_{3} - {m}_{1} )}^{2}}} \vert ,$$

the distance between the optical camera and the right lane line is

$$d c r = \vert \frac{h f}{tan {θ}_{1} \sqrt{{f}^{2} + {( {m}_{3} - {m}_{1} )}^{2}}} \vert ;$$

S4: calculating the distance between the vehicle and each of the left and right lane lines;

where the transverse minimum distance between the vehicle and the left lane line is:

$$d l = min ( \vert \frac{- f b - ( {m}_{3} - {m}_{1} ) a + h f}{tan {θ}_{2} \sqrt{{f}^{2} + {( {m}_{3} - {m}_{1} )}^{2}}} \vert , \vert \frac{- f b - ( {m}_{3} - {m}_{1} ) ( a - l ) + h f}{tan {θ}_{2} \sqrt{{f}^{2} + {( {m}_{3} - {m}_{1} )}^{2}}} \vert ) ,$$

the transverse maximum distance between the vehicle and the left lane line is:

$$d {l}^{′} = max ( \vert \frac{- f b - ( {m}_{3} - {m}_{1} ) a + h f}{tan {θ}_{2} \sqrt{{f}^{2} + {( {m}_{3} - {m}_{1} )}^{2}}} \vert , \vert \frac{- f b - ( {m}_{3} - {m}_{1} ) ( a - l ) + h f}{tan {θ}_{2} \sqrt{{f}^{2} + {( {m}_{3} - {m}_{1} )}^{2}}} \vert ) ,$$

the transverse minimum distance between the vehicle and the right lane line is

$$d r = min ( \vert \frac{\begin{matrix}- f ( w - b ) - \\ ( {m}_{3} - {m}_{1} ) a + h f\end{matrix}}{tan {θ}_{1} \sqrt{{f}^{2} + {( {m}_{3} - {m}_{1} )}^{2}}} \vert , \vert \frac{\begin{matrix}- f ( w - b ) - \\ ( {m}_{3} - {m}_{1} ) ( a - l ) + h f\end{matrix}}{tan {θ}_{1} \sqrt{{f}^{2} + {( {m}_{3} - {m}_{1} )}^{2}}} \vert ) ,$$

the transverse maximum distance between the vehicle and the right lane line is:

$$d {r}^{′} = max ( \vert \frac{\begin{matrix}- f ( w - b ) - \\ ( {m}_{3} - {m}_{1} ) a + h f\end{matrix}}{tan {θ}_{1} \sqrt{{f}^{2} + {( {m}_{3} - {m}_{1} )}^{2}}} \vert , \vert \frac{\begin{matrix}- f ( w - b ) - \\ ( {m}_{3} - {m}_{1} ) ( a - l ) + h f\end{matrix}}{tan {θ}_{1} \sqrt{{f}^{2} + {( {m}_{3} - {m}_{1} )}^{2}}} \vert )$$

where w is vehicle width, and l is vehicle length;

S5: taking three consecutive images, defining the average value of calculated distances as the distance value, wherein if dl<min_warn_dist or dr<min_warn_dist, min_warn_dist is a pre-defined distance value for early warning, the system sends a distance-related early-warning prompt.

Compared with the prior art, the present invention has the following beneficial effects:

The system for effectively identifying pressing line of vehicle and giving an early-warning prompt according to the present invention effectively calculates the transverse distance between the vehicle and the lane line in real time; the present invention has the advantages of simple design, easy development, high reliability, no need of vehicle refitting and independence from the outside; and the present invention can bring convenience and safe driving experience to drivers.

### BRIEF DESCRIPTION OF THE SEVERAL VIEWS OF THE DRAWINGS

FIG. 1 is a lateral view of installation of a system for effectively identifying pressing line of vehicle and giving an early-warning prompt according to the present invention;

FIG. 2 is a top view of installation of a system for effectively identifying pressing line of vehicle and giving an early-warning prompt according to the present invention;

FIG. 3 is a schematic view of a lane line acquired by an optical camera according to the present invention;

FIG. 4 is a schematic view of any position of a vehicle running on a road according to the present invention;

FIG. 5 is a schematic diagram of the present invention.

### DETAILED DESCRIPTION OF THE INVENTION

The following are description of the present invention in further detail with reference to the accompanying drawings and specific examples.

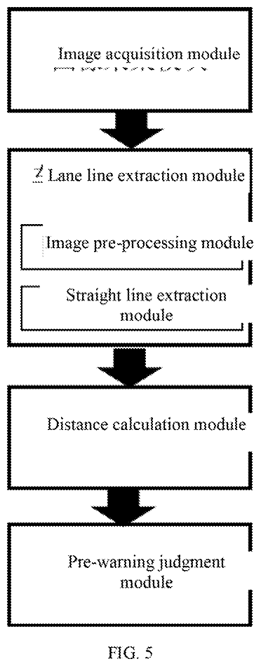

Refer to FIG. 5. The present invention provides a system for effectively identifying pressing line of vehicle and giving an early-warning prompt, including an image acquisition module, a lane line extraction module, a distance calculation module and an early-warning judgment module, characterized in that the image acquisition module acquires image information through an optical camera and inputs the image information into the lane line extraction module;

the lane line extraction module processes the image information, extracts lane line information, and inputs the extracted lane line information into the distance calculation module;

the lane line extraction module further includes an image pre-processing module and a straight line extraction module;

the image pre-processing module Graying the image, then smoothens the image by mean filtering, extracts margins in the image with a Canny operator, and removes small margins by opening operation;

the straight line extraction module extracts a straight line within a limited angle by Hough conversion, judges whether a lane line is a yellow solid line using the original image color characteristics, and judges a dotted line and a solid line through periodic gray conversion of the lane line;

the distance calculation module processes the lane line information, calculates a transverse distance between the vehicle and each of left and right lane lines, and inputs the calculation result into the pre-warning judgment module; and,

the pre-warning judgment module judges whether the transverse distance between the vehicle and each of left and right lane lines obtained by the distance calculation module through processing and calculation exceeds a pre-defined distance value for early warning, and if so, gives a driver an early-warning signal.

In one embodiment of the present invention, further, the distance calculation module processes the lane line information and calculates a transverse distance between the vehicle and each of left and right lane lines by a method including the following steps:

S1: installing the optical camera at a windscreen of the vehicle, where the optical axis is parallel to the ground, the horizontal height is h, the distance to the head of the vehicle is a, the distance to the left side of the vehicle is b, and the focal length is f;

S2: processing, by the lane line extraction module, the image information acquired by the optical camera to obtain the left and right lane lines in the image that are plane projection of left and right lane lines on a pavement, where in an image coordinates system, the left and right lane lines are crossed at B(m₃,m₂) on a hidden line, the central line of the image and the hidden line are crossed at point A(m₁,m₂), and the angle between each of the left and right lane lines and the axis x of the image coordinates system is θ₁,θ₂;

S3: calculating the distance between the optical camera and each of the left and right lane lines;

where the distance between the optical camera and the left lane line is

$$d c l = \vert \frac{h f}{tan {θ}_{2} \sqrt{{f}^{2} + {( {m}_{3} - {m}_{1} )}^{2}}} \vert ,$$

the distance between the optical camera and the right lane line is

$$d c r = \vert \frac{h f}{tan {θ}_{1} \sqrt{{f}^{2} + {( {m}_{3} - {m}_{1} )}^{2}}} \vert ;$$

S4: calculating the distance between the vehicle and each of the left and right lane lines;

where the transverse minimum distance between the vehicle and the left lane line is:

$$d l = min ( \vert \frac{- f b - ( {m}_{3} - {m}_{1} ) a + h f}{tan {θ}_{2} \sqrt{{f}^{2} + {( {m}_{3} - {m}_{1} )}^{2}}} \vert , \vert \frac{- f b - ( {m}_{3} - {m}_{1} ) ( a - l ) + h f}{tan {θ}_{2} \sqrt{{f}^{2} + {( {m}_{3} - {m}_{1} )}^{2}}} \vert ) ,$$

the transverse maximum distance between the vehicle and the left lane line is:

$$d {l}^{′} = max ( \vert \frac{- f b - ( {m}_{3} - {m}_{1} ) a + h f}{tan {θ}_{2} \sqrt{{f}^{2} + {( {m}_{3} - {m}_{1} )}^{2}}} \vert , \vert \frac{- f b - ( {m}_{3} - {m}_{1} ) ( a - l ) + h f}{tan {θ}_{2} \sqrt{{f}^{2} + {( {m}_{3} - {m}_{1} )}^{2}}} \vert ) ,$$

the transverse minimum distance between the vehicle and the right lane line is:

$$dr = min ( \vert \frac{\begin{matrix}- f ( w - b ) - \\ ( {m}_{3} - {m}_{1} ) a + h f\end{matrix}}{tan {θ}_{1} \sqrt{{f}^{2} + {( {m}_{3} - {m}_{1} )}^{2}}} \vert , \vert \frac{\begin{matrix}- f ( w - b ) - \\ ( {m}_{3} - {m}_{1} ) ( a - l ) + h f\end{matrix}}{tan {θ}_{1} \sqrt{{f}^{2} + {( {m}_{3} - {m}_{1} )}^{2}}} \vert ) ,$$

the transverse maximum distance between the vehicle and the right lane line is:

$$d {r}^{′} = max ( \vert \frac{\begin{matrix}- f ( w - b ) - \\ ( {m}_{3} - {m}_{1} ) a + h f\end{matrix}}{tan {θ}_{1} \sqrt{{f}^{2} + {( {m}_{3} - {m}_{1} )}^{2}}} \vert , \vert \frac{\begin{matrix}- f ( w - b ) - \\ ( {m}_{3} - {m}_{1} ) ( a - l ) + h f\end{matrix}}{tan {θ}_{1} \sqrt{{f}^{2} + {( {m}_{3} - {m}_{1} )}^{2}}} \vert )$$

where w is vehicle width, and l is vehicle length;

S5: taking three consecutive images, defining the average value of calculated distances as the distance value, wherein if dl<min_warn_dist or dr<min_warn_dist, min_warn_dist is a pre-defined distance value for early warning, the system sends a distance-related early-warning prompt.

To help those ordinarily skilled in the art better understand the technical solution of the present invention, the following are description of the present invention in detail in conjunction with the attached drawings.

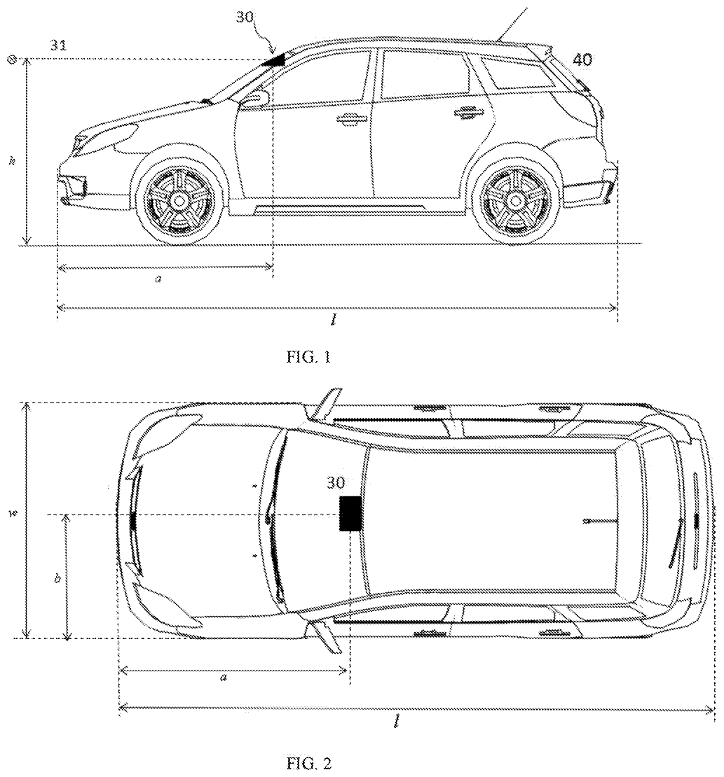

Refer to FIG. 1 and FIG. 2. In one embodiment of the present invention, a camera 30 is installed in a vehicle 40, behind the windscreen; the camera faces towards horizontally, the optical axis 31 of the camera is parallel to the ground; and the camera is installed at a height of h; the distance to the head of the vehicle is a, and to the left side of the vehicle is b; and the calibrated focal length is f. Before extraction of a lane line, a RGB image is pre-processed to convert the RGB image into a gray-scale image; 3×3 mean filtering is carried out to the smooth the gray-scale image so as to remove interference; a Canny operator is used to extract margins of the image; opening operation is applied to remove small margins of the image; Hough conversion is carried out to extract a straight line as the lane line within a limited angel; color characteristics are extracted at the lane line position in the original RGB image to judge whether the lane line is a yellow line or a white line; and whether the lane line is a dotted line or a solid line is judged according to the periodical conversion of the gray-scale brightness of the lane line.

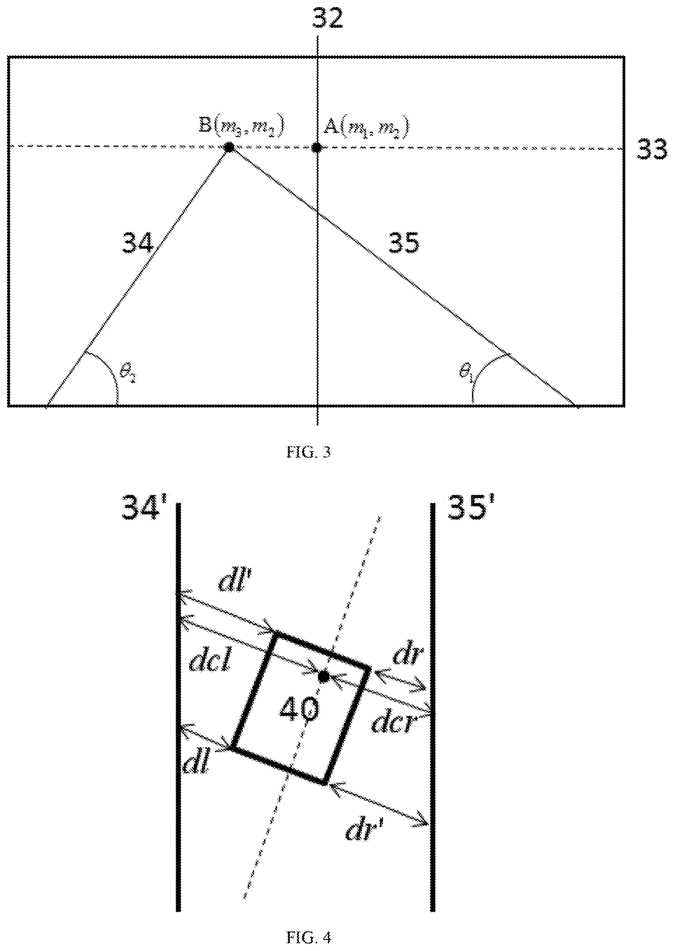

Refer to FIG. 3 and FIG. 4, the vehicle 40 is running on a left lane 34′ and a right lane 35′; the camera acquires images, extract lane lines, and then detects that a lane line 34 and a lane line 35 in the images are the projection of the left lane 34′ and the right lane 35′ on the pavement, respectively. A hidden line 33 in FIG. 3 and a line 32 in the figure are crossed at point A(m₁,m₂); and the crossing point B(m₁,m₂) of the lane lines 34 and 35 is located on the hidden line 33, and the angle between each of the lane lines 34 and 35 and the axis x of the image is θ₁,θ₂, respectively. The optical axis 31 of the camera 30 is not parallel to the ground due to pitching of the vehicle, so that the crossing point B(m₃,m₂) of the lane lines 34 and 35 in FIG. 3 is not located on the hidden line 33. Under such circumstance, the distance between the vehicle 40 and each of the left and right lanes 34′ and 35′ when the point B is located out the range of the ±5 pixel of the hidden line is not calculated. Three consecutive images are taken, and the average value of calculated distances is defined as the distance value.

Refer to FIG. 4. If dl<min_warn_dist or dr<min_warn_dist, the system gives the driver an alarm, where min_warn_dis=20 cm.

If the time that the vehicle rides the white dotted line is too long, time>max_time, where max_time=5 s, the system gives the driver an alarm.

The above is merely one preferable embodiment of the present invention. All equivalent changes and modifications made on the basis of the present invention shall fall within the protective scope of the present invention.

What is claimed is:

1. A system for effectively identifying pressing line of vehicle and giving an early-warning prompt, comprising an image acquisition module, a lane line extraction module, a distance calculation module and an early-warning judgment module, characterized in that the image acquisition module acquires image information through an optical camera and inputs the image information into the lane line extraction module;
the lane line extraction module further comprises an image pre-processing module and a straight line extraction module;
the image pre-processing module Graying the image, then smooths the image by mean filtering, extracts margins in the image with a Canny operator, and removes small margins by opening operation to obtain pre-processed image information;
the straight line extraction module extracts a straight line within a limited angle by Hough conversion according to the pre-processed information to obtain lane line information;
the distance calculation module processes the lane line information, calculates a transverse distance between the vehicle and each of left and right lane lines, and inputs the calculation result into the pre-warning judgment module; and,
the pre-warning judgment module judges whether the transverse distance between the vehicle and each of left and right lane lines obtained by the distance calculation module through processing and calculation exceeds a pre-defined distance value for early warning, and if so, gives a driver an early-warning signal.

2. The system for effectively identifying pressing line of vehicle and giving an early-warning prompt according to claim 1, wherein the distance calculation module processes the lane line information and calculates a transverse distance between the vehicle and each of left and right lane lines by a method comprising the following steps:
S1: installing the optical camera at a windscreen of the vehicle, wherein the optical axis is parallel to the ground, the horizontal height is h, the distance to the head of the vehicle is a, the distance to the left side of the vehicle is b, and the focal length is f;
S2: processing, by the lane line extraction module, the image information acquired by the optical camera to obtain the left and right lane lines in the image that are plane projection of left and right lane lines on a pavement, wherein in an image coordinates system, the left and right lane lines are crossed at B(m₃,m₂) on a hidden line, the central line of the image and the hidden line are crossed at point A(m₁,m₂), and the angle between each of the left and right lane lines and the axis x of the image coordinates system is θ₁,θ₂;
S3: calculating the distance between the optical camera and each of the left and right lane lines;
wherein the distance between the optical camera and the left lane line is
$$d c l = \vert \frac{h f}{tan {θ}_{2} \sqrt{{f}^{2} + {( {m}_{3} - {m}_{1} )}^{2}}} \vert ,$$
the distance between the optical camera and the right lane line is
$$d c r = \vert \frac{h f}{tan {θ}_{1} \sqrt{{f}^{2} + {( {m}_{3} - {m}_{1} )}^{2}}} \vert ;$$
S4: calculating the distance between the vehicle and each of the left and right lane lines;
wherein the transverse minimum distance between the vehicle and the left lane line is:
$$d l = min ( \vert \frac{- f b - ( {m}_{3} - {m}_{1} ) a + h f}{tan {θ}_{2} \sqrt{{f}^{2} + {( {m}_{3} - {m}_{1} )}^{2}}} \vert , \vert \frac{- f b - ( {m}_{3} - {m}_{1} ) ( a - l ) + h f}{tan {θ}_{2} \sqrt{{f}^{2} + {( {m}_{3} - {m}_{1} )}^{2}}} \vert ) ,$$
the transverse maximum distance between the vehicle and the left lane line is:
$$d {l}^{′} = max ( \vert \frac{- f b - ( {m}_{3} - {m}_{1} ) a + h f}{tan {θ}_{2} \sqrt{{f}^{2} + {( {m}_{3} - {m}_{1} )}^{2}}} \vert , \vert \frac{- f b - ( {m}_{3} - {m}_{1} ) ( a - l ) + h f}{tan {θ}_{2} \sqrt{{f}^{2} + {( {m}_{3} - {m}_{1} )}^{2}}} \vert ) ,$$
the transverse minimum distance between the vehicle and the right lane line is:
$$dr = min ( \vert \frac{\begin{matrix}- f ( w - b ) - \\ ( {m}_{3} - {m}_{1} ) a + h f\end{matrix}}{tan {θ}_{1} \sqrt{{f}^{2} + {( {m}_{3} - {m}_{1} )}^{2}}} \vert , \vert \frac{\begin{matrix}- f ( w - b ) - \\ ( {m}_{3} - {m}_{1} ) ( a - l ) + h f\end{matrix}}{tan {θ}_{1} \sqrt{{f}^{2} + {( {m}_{3} - {m}_{1} )}^{2}}} \vert ) ,$$
the transverse maximum distance between the vehicle and the right lane line is:
$$d {r}^{′} = max ( \vert \frac{\begin{matrix}- f ( w - b ) - \\ ( {m}_{3} - {m}_{1} ) a + h f\end{matrix}}{tan {θ}_{1} \sqrt{{f}^{2} + {( {m}_{3} - {m}_{1} )}^{2}}} \vert , \vert \frac{\begin{matrix}- f ( w - b ) - \\ ( {m}_{3} - {m}_{1} ) ( a - l ) + h f\end{matrix}}{tan {θ}_{1} \sqrt{{f}^{2} + {( {m}_{3} - {m}_{1} )}^{2}}} \vert ) ,$$
wherein w is vehicle width, and l is vehicle length;
S5: taking three consecutive images, defining the average value of calculated distances as the distance value, wherein if dl<min_warn_dist or dr<min_warn_dist, min_warn_dist is a pre-defined distance value for early warning, the system sends a distance-related early-warning prompt.
